(19) United States
(12) Patent Application Publication
(10) Pub. No.: US 2025/0219364 A1
(43) Pub. Date: Jul. 3, 2025

(54) CABLE MANAGEMENT DEVICE CONFIGURED TO PERMIT CHANGING OF AN ANGULAR ORIENTATION OF A CABLE MANAGEMENT SURFACE AND TO PROVIDE THE CABLE ENGAGEMENT SURFACE WITH ENHANCED STRENGTH FOR SUPPORTING AND ROUTING CABLES

(71) Applicant: PPC BROADBAND, INC., East Syracuse, NY (US)

(72) Inventor: Robert KAUßMANN, East Syracuse, NY (US)

(73) Assignee: PPC BROADBAND, INC., East Syracuse, NY (US)

(21) Appl. No.: 19/005,285

(22) Filed: Dec. 30, 2024

Related U.S. Application Data
(60) Provisional application No. 63/616,369, filed on Dec. 29, 2023.

(51) Int. Cl. H02G 1/06; G02B 6/46

(52) U.S. Cl. CPC H02G 1/06; G02B 6/475

(57) ABSTRACT

A device for managing communication cables within an enclosure structurally configured to permit changing of an angular orientation of the cable engagement surface and to provide the cable engagement surface with enhanced strength for supporting and routing cables inside the enclosure. The device may include a proximal end portion, a distal end portion, and a cable engagement portion extending between the proximal end portion and the distal end portion. The cable engagement portion may be structurally configured to engage the one or more communication cables. The proximal end portion may include a mounting portion structurally configured to allow the angular orientation of the device within the enclosure to be changed without detaching the device from the enclosure.

### CROSS-REFERENCE TO RELATED APPLICATIONS

This application claims the benefit of U.S. Provisional Patent Application No. 63/616,369, filed Dec. 29, 2023, the disclosure of which is hereby incorporated by reference herein in its entirety.

### TECHNICAL FIELD

The present disclosure relates generally to cable management, and more particularly to a cable management device configured to permit changing of an angular orientation of a cable engagement surface and to provide the cable engagement surface with enhanced strength for supporting and routing cables inside an enclosure.

### BACKGROUND

Enclosures (e.g., cabinets) are used to protect communication cables (e.g., fiber optic or copper cable) and other components from environmental conditions within a distribution network. These fully enclosed enclosures are also designed to organize and manage rack-mountable hardware. Within these enclosures, the communication cables can be spliced, split, patched, routed, and terminated as needed. Since many communication cables can originate, terminate, or be routed through the enclosures, cable management within the enclosure is important. There is a need for a sturdy and versatile cable management device for within enclosures.

It may be desirable to provide a cable management device that is configured to permit changing of an angular orientation of a cable engagement surface and to provide the cable engagement surface with enhanced strength for supporting and routing cables.

### SUMMARY

The present disclosure provides a device for managing one or more communication cables inside an enclosure. The device may be structurally configured to permit changing of an angular orientation of a cable engagement surface and to provide the cable engagement surface with enhanced strength for supporting and routing cables inside the enclosure.

In some embodiments, the device may include a proximal end portion, a distal end portion opposite the proximal end portion, and a cable engagement portion extending along a longitudinal axis between the proximal end portion and the distal end portion. In some embodiments, the cable engagement portion may define a cable engagement surface structurally configured to engage a communication cable.;

In some embodiments, the proximal end portion may include a mounting portion structurally configured to mount to an enclosure.

In some embodiments, the mounting portion may be structurally configured to allow the cable engagement surface to pivot about the longitudinal axis so as to permit an angular orientation of the cable engagement surface to be changed without detaching the mounting portion from the enclosure.

In some embodiments, the proximal end portion may include a first guiding member mounting portion structurally configured to mount a cable guiding member to the proximal end portion. In some embodiments, the cable guiding member may be structurally configured to extend along the cable engagement surface from the proximal end portion to the distal end portion and spaced radially outward of the cable engagement surface.

In some embodiments, the distal end portion may include a second guiding member mounting portion structurally configured to mount the cable guiding member to the distal end portion.

In some embodiments, the cable management device may be structurally configured to permit changing of an angular orientation of the cable engagement surface and to provide the cable engagement surface with enhanced strength for supporting and routing cables inside the enclosure.

In some embodiments, the cable engagement portion may include a first cable engagement portion structurally configured to interlock with a second cable engagement portion so as to provide a cylindrical cable engagement surface having enhanced strength for supporting and routing cables.

In some embodiments, the distal end portion may include a first distal end portion structurally configured to span across and connect to both the first cable engagement portion and the second cable engagement portion and a second distal end portion structurally configured to span across and connect to both the first cable engagement portion and the second cable engagement portion adjacent the first distal end portion.

In some embodiments, the second guiding member mounting portion may include a plurality of circumferentially spaced attachment points.

In some embodiments, the second guiding member mounting portion may include a first guiding member attachment point, a second guiding member attachment point spaced from the first guiding member attachment point, and a third guiding member attachment point spaced apart from the first guiding member attachment point and the second guiding member attachment point.

In some embodiments, the first guiding member attachment point may be positioned near a radially outer edge of the distal end portion, the second guiding member attachment point may be positioned near the radially outer edge offset 40-80 degrees from the first guiding member attachment point, and the third guiding member attachment point may be positioned near the radially outer edge offset 40-80 degrees from the second guiding member attachment point.

In some embodiments, the first guiding member mounting portion may be structurally configured to mount a ball cable tie and include a proximally extending second projection structurally configured to be received in a ball end of the ball cable tie and an opening through which the ball cable tie extend distally. In some embodiments, the plurality of circumferentially spaced attachment points may be structurally configured to engage a bead of the ball cable tie to secure the ball cable tie at the distal end portion.

In some embodiments, the cable engagement surface may be convex.

In some embodiments, the mounting portion may include a proximally extending projection structurally configured to be received within a recess of the enclosure and a first curved slot structurally configured to receive a mounting fastener of attaching the device to the enclosure.

In some embodiments, the mounting portion may be structurally configured to attach to the cable engagement portion with one or more fasteners.

In some embodiments, a device for managing communication cables within an enclosure may include a proximal end portion, a distal end portion opposite the proximal end portion, and a cable engagement portion extending along a longitudinal axis between the proximal end portion and the distal end portion.

In some embodiments, the cable engagement portion may define a cable engagement surface structurally configured to engage a communication cable.

In some embodiments, the proximal end portion may include a mounting portion structurally configured to mount to an enclosure.

In some embodiments, the mounting portion may include a proximally extending projection structurally configured to be received within a recess of the enclosure and a first curved slot structurally configured to receive a mounting fastener of attaching the device to the enclosure.

In some embodiments, the mounting portion may be structurally configured to allow the cable engagement surface to pivot about the longitudinal axis so as to permit an angular orientation of the cable engagement surface to be changed without detaching the mounting portion from the enclosure.

In some embodiments, the proximal end portion may include a first guiding member mounting portion structurally configured to mount a cable guiding member to the proximal end portion. In some embodiments, the cable guiding member may be structurally configured to extend along the cable engagement surface from the proximal end portion to the distal end portion and spaced radially outward of the cable engagement surface.

In some embodiments, the distal end portion may include a second guiding member mounting portion structurally configured to mount the cable guiding member to the distal end portion.

In some embodiments, the second guiding member mounting portion may include a first guiding member attachment point, a second guiding member attachment point spaced from the first guiding member attachment point, and a third guiding member attachment point spaced apart from the first guiding member attachment point and the second guiding member attachment point. In some embodiments, the first guiding member attachment point may be positioned near a radially outer edge of the distal end portion, the second guiding member attachment point may be positioned near the radially outer edge offset 40-80 degrees from the first guiding member attachment point, and the third guiding member attachment point may be positioned near the radially outer edge offset 40-80 degrees from the second guiding member attachment point.

In some embodiments, the cable engagement portion may include a first cable engagement portion structurally configured to interlock with a second cable engagement portion so as to provide a cylindrical cable engagement surface having enhanced strength for supporting and routing cables.

In some embodiments, the cable management device may be structurally configured to permit changing of an angular orientation of the cable management surface and to provide the cable management surface with enhanced strength for supporting and routing cables inside the enclosure.

In some embodiments, first cable engagement surface may be convex.

In some embodiments, the mounting portion may be structurally configured to attach to the cable engagement portion with one or more fasteners.

In some embodiments, the distal end portion may include a first distal end portion structurally configured to span across and connect to both the first cable engagement portion and the second cable engagement portion and a second distal end portion structurally configured to span across and connect to both the first cable engagement portion and the second cable engagement portion adjacent the first distal end portion.

In some embodiments, the first guiding member mounting portion may be structurally configured to mount a ball cable tie and includes a proximally extending second projection structurally configured to be received in a ball end of the ball cable tie and an opening through which the ball cable tie extend distally. In some embodiments, each of the first, second, and third cable guiding member attachment points may be structurally configured to engage a bead of the ball cable tie to secure the ball cable tie at the distal end portion.

In some embodiments, a device for managing communication cables within an enclosure may include a proximal end portion, a distal end portion opposite the proximal end portion, and a cable engagement portion extending along a longitudinal axis between the proximal end portion and the distal end portion. In some embodiments, the cable engagement portion may define a cable engagement surface structurally configured to engage a communication cable.

In some embodiments, the proximal end portion may include a mounting portion structurally configured to mount to an enclosure. In some embodiments, the mounting portion may be structurally configured to allow the cable engagement surface to pivot about the longitudinal axis so as to permit an angular orientation of the cable engagement surface to be changed without detaching the mounting portion from the enclosure.

In some embodiments, the proximal end portion may include a first guiding member mounting portion structurally configured to mount a cable guiding member to the proximal end portion. In some embodiments, the cable guiding member may be structurally configured to extend along the cable engagement surface from the proximal end portion to the distal end portion and spaced radially outward of the cable engagement surface.

In some embodiments, the distal end portion may include a second guiding member mounting portion structurally configured to mount the cable guiding member to the distal end portion.

In some embodiments, the second guiding member mounting portion may include a plurality of circumferentially spaced attachment points.

In some embodiments, the cable engagement portion may include a first cable engagement portion structurally configured to interlock with a second cable engagement portion so as to provide a cylindrical cable engagement surface having enhanced strength for supporting and routing cable.

In some embodiments, the cable management device may be structurally configured to permit changing of an angular orientation of the cable engagement surface and to provide the cable engagement surface with enhanced strength for supporting and routing cables inside the enclosure.

In some embodiments, the second guiding member mounting portion may include a first guiding member attachment point, a second guiding member attachment point spaced from the first guiding member attachment point, and a third guiding member attachment point spaced apart from the first guiding member attachment point and the second guiding member attachment point.

In some embodiments, the first guiding member attachment point may be positioned near a radially outer edge of the distal end portion, the second guiding member attachment point may be positioned near the radially outer edge offset 40-80 degrees from the first guiding member attachment point, and the third guiding member attachment point may be positioned near the radially outer edge offset 40-80 degrees from the second guiding member attachment point.

In some embodiments, the distal end portion may include a first distal end portion structurally configured to span across and connect to both the first cable engagement portion and the second cable engagement portion and a second distal end portion structurally configured to span across and connect to both the first cable engagement portion and the second cable engagement portion adjacent the first distal end portion.

In some embodiments, the cable engagement surface may be convex.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a perspective view of an example cable management device.

FIG. 2 is a perspective view of an example cable engagement portion of the cable management device of FIG. 1.

FIG. 3 is a front view of the cable engagement portion of FIG. 2.

FIG. 4 is rear perspective view of a proximal end portion of the cable management device of FIG. 1.

FIG. 5 is a front view of the proximal end portion of FIG. 4.

FIG. 6 is a rear view of a distal end portion of the cable management device of FIG. 1.

FIG. 7 is a side view of an example cable guiding member.

FIG. 8 is a perspective view of the cable management device of FIG. 1 with the cable guiding member of FIG. 7 attached.

FIG. 9 is a perspective view of an example cable management device.

FIG. 10 is a front view of a cable engagement portion of the cable management device of FIG. 9.

FIG. 11 is a rear view of an example distal end portion of the cable management device.

### DETAILED DESCRIPTION

Reference will now be made in detail to presently preferred embodiments and methods of the present disclosure, which constitute the best modes of practicing the present disclosure presently known to the inventors. The figures are not necessarily to scale. It is to be understood, however, that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

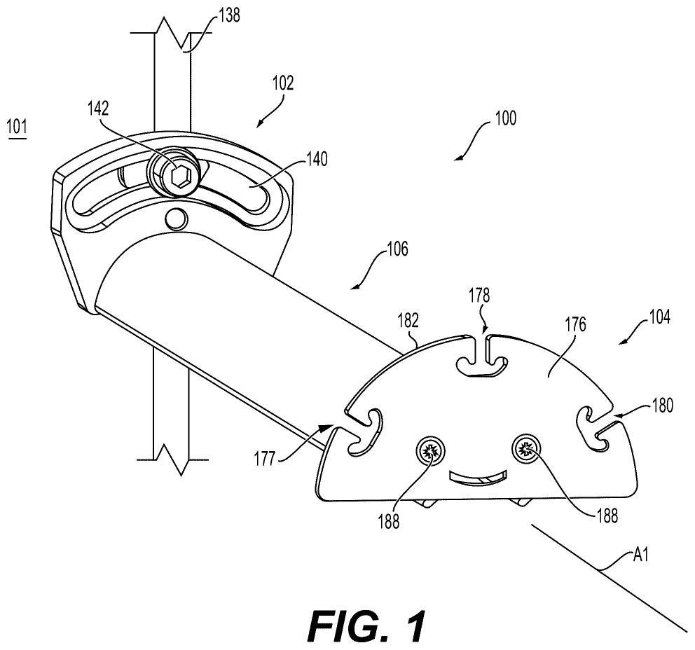

Referring to FIG. 1, embodiments of the disclosure provide a cable management device 100 structurally configured to engage and route one or more communication cables (e.g., fiber optic cables, copper coaxial cables) and/or fibers within an enclosure 101 (e.g., cabinet). In some implementations, the cable management device 100 may be structurally configured to be mounted within the enclosure 101. In some implementations, the cable management device 100 may be structurally configured such that the orientation of the cable management device 100 within the enclosure 101 can be changed without detaching the cable management device 100 from the enclosure 101.

In some implementations, the cable management device 100 may include a first proximal end portion 102 a first distal end portion 104, and a first cable engagement portion 106 extending along a longitudinal axis A1 between the first proximal end portion 102 and the first distal end portion 104. The first cable engagement portion 106 may be structurally configured to engage the one or more communication cables to assist in routing the one or more communication cables within the enclosure 101.

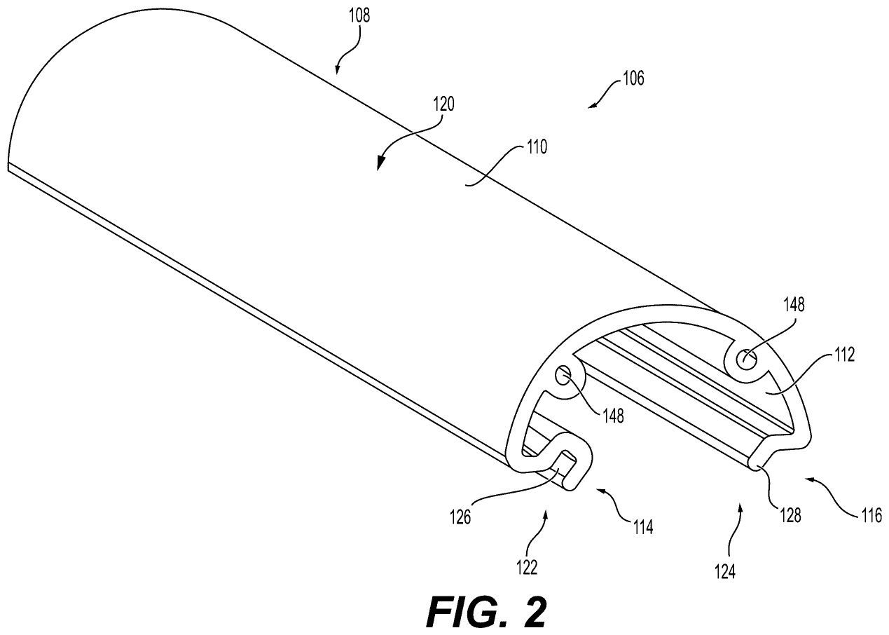

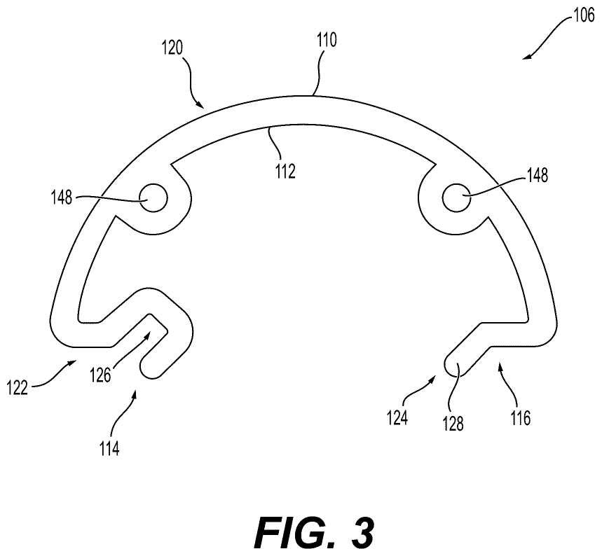

Referring to FIGS. 2-3, the first cable engagement portion 106 may be configured in a variety of ways, including shape, size, material, and orientation. In some implementations, the first cable engagement portion 106 may inlcude an elongated body 108 having a first surface 110, a second surface 112 opposite the first surface 110, a first lateral edge portion 114 extending between the first surface 110 and the second surface 112, and a second lateral edge portion 116 opposite the first lateral edge portion 114 and extending between the first surface 110 and the second surface 112.

In some implementations, the first surface 110 may define a first cable engagement surface 120 structurally configured to engage the one or more communication cables. The first cable engagement surface 120 may be configured in a variety of ways. In some implementations, the first cable engagement surface 120 may be curved or convex. For example, in some implementations, the first cable engagement surface 120 may have a semi-circular profile. In some implementations, the first cable engagement surface 120 may be smooth. In other implementations, the first cable engagement surface 120 can be other than smooth (e.g., textured, longitudinally or laterally ribbed, etc.). In some implementations, the second surface 112 may be parallel, or generally parallel, to the first cable engagement surface 120; thus, the second surface 112 may have the same or similar profile (e.g., curved, semicircular) to the first cable engagement surface 120. In other implementations, however, the second surface 112 may have a different profile than the first cable engagement surface 120.

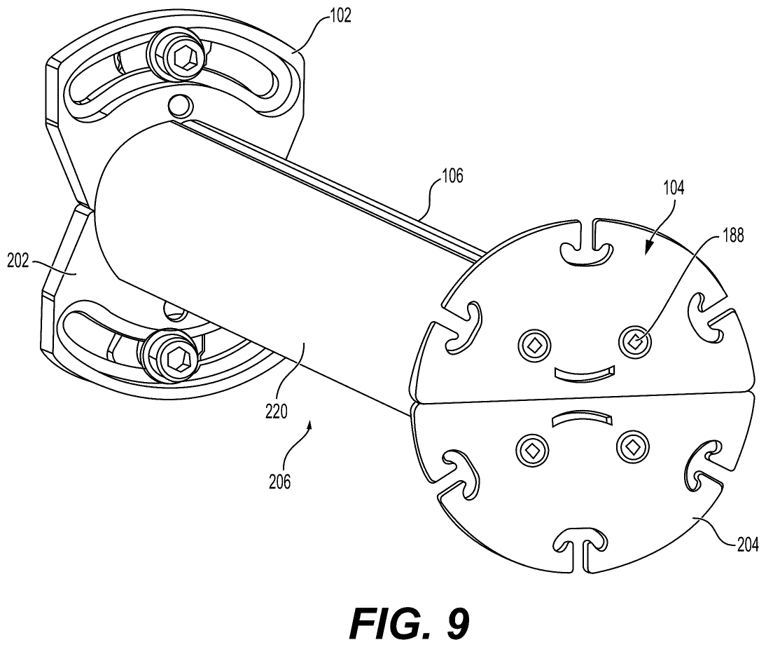

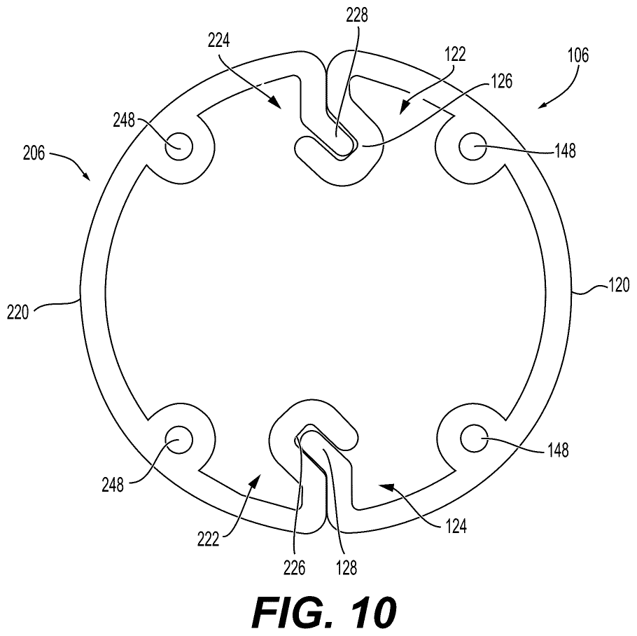

In some implementations, the first cable engagement portion 106 may be structurally configured to attach to a second cable engagement portion 206 (FIGS. 9-10). The first cable engagement portion 106 can be structurally configured to attach to the second cable engagement portion 206 in a variety of ways. For example, the first cable engagement portion 106 may attach to a second cable engagement portion via a snap connection, a tongue-and-groove connection, a friction fit, a clasp, a latch, or other suitable connecting means. In some implementations, the first cable engagement portion 106 be structurally configured to interlock with the second cable engagement portion 206.

In some implementations, the first cable engagement portion 106 may include a first connecting portion 122 arranged at or along the first lateral edge portion 114 and a second connecting portion 124 arranged at or along the second lateral edge portion 116. In some implementations, the first connecting portion may include a longitudinally-extending groove 126. In some implementations, the first connecting portion 122 may have an S-shaped cross section. In some implementations, the second connecting portion 124 may include a longitudinally-extending ridge 128.

The first cable engagement portion 106 can be made from any suitable materials. In some implementations, the first cable engagement portion 106 may be made from a plastic. In some implementations, the first cable engagement portion 106 may be extruded.

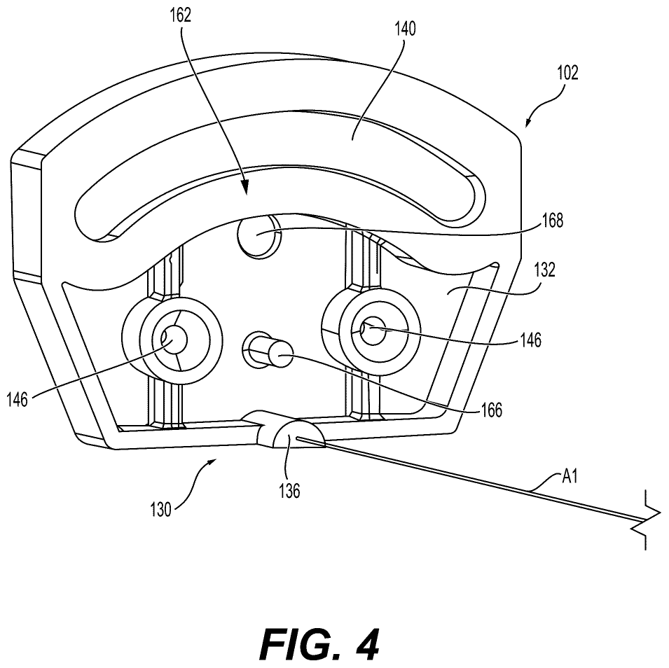

Referring to FIG. 4, in some implementations, the first proximal end portion 102 may include a first device mounting portion 130 structurally configured to mount to the enclosure 101. The first device mounting portion 130 may be configured in a variety of ways. In some implementations, the first device mounting portion 130 may be structurally configured to allow the cable management device 100 to pivot about the longitudinal axis A1 without detaching the cable management device 100 from the enclosure 101.

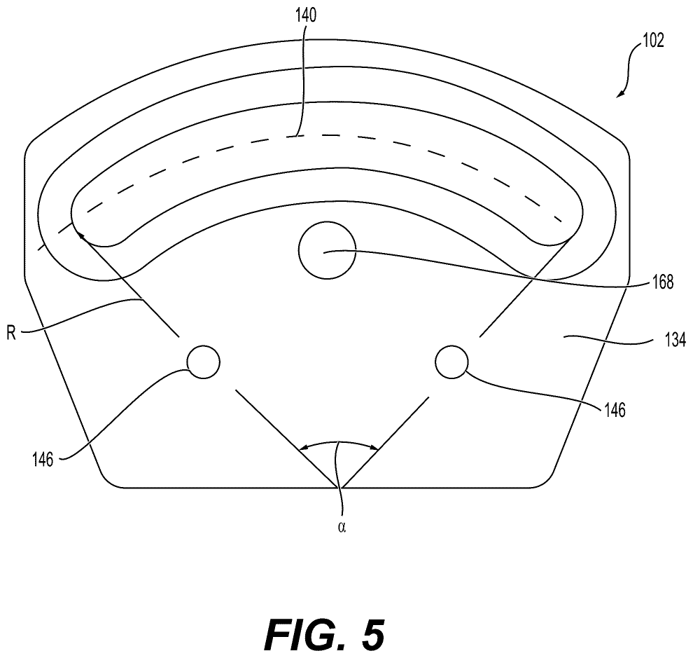

In some implementations, the first proximal end portion 102 may include a first face 132 (FIG. 4) and a second face 134 (FIG. 5) opposite the first face 132. In some implementations, the first device mounting portion 130 may include a first projection 136 extending proximally from the first face 132 and structurally configured to be received within a recess 138 (e.g., a channel, a slot, an opening, etc.) of the enclosure 101 (FIG. 1) to act as a pivot pin (i.e., the cable management device 100 may pivot about the first projection 136).

In some implementations, the first device mounting portion 130 may include a fastener receiving slot 140 structurally configured to receive a first fastener 142 (FIG. 1) for mounting the cable management device 100 to the enclosure 101. In some implementations, the fastener receiving slot 140 may be curved with a constant radius R such that as the cable management device 100 pivots about the first projection 136, the first fastener 142 moves along the fastener receiving slot 140. In some implementations, the fastener receiving slot 140 may extend along an arc having an angular length a in the range of 60 degrees to 100 degrees, 70 degrees to 90 degrees, or about 78 degrees.

In some implementations, the first proximal end portion 102 may be formed integrally with the first cable engagement portion 106. In other implementations, the first proximal end portion 102 may be separate from the first cable engagement portion 106 and may be structurally configured to attach to the first cable engagement portion 106. The first proximal end portion 102 may be structurally configured to attach to the first cable engagement portion 106 in a variety of ways. In some implementations, the first proximal end portion 102 may be structurally configured to attach to the first cable engagement portion 106 by one or more fasteners (not shown) (e.g., screws, bolts, etc.). For example, in the illustrated implementation, the first proximal end portion 102 may include one or more first fastener receiving openings 146 structurally configured to receive the one or more fasteners to attach the first proximal end portion 102 to the first cable engagement portion 106.

Correspondingly, the first cable engagement portion 106 may include one or more second fastener receiving openings 148 for receiving the one or more fasteners (e.g., the same or similar to fasteners 188 illustrated in FIG. 1). For example, in some implementations, the one or more second fastener receiving openings 148 may be arranged on the second surface 112 (e.g., attached to and radially inward of the second surface 112) adjacent the first proximal end portion 102. In some implementations, the one or more second fastener receiving openings 148 may be arranged at both the first proximal end portion 102 and the first distal end portion 104. For example, in some implementations, the one or more second fastener receiving openings 148 may extend along the length of the first cable engagement portion 106 from the first proximal end portion 102 to the first distal end portion 104.

The spacing and orientation of the one or more second fastener receiving openings 148 may align with the spacing and orientation of one or more first fastener receiving openings 146 such that the one of the one or more fasteners may be received through one of the first fastener receiving openings 146 and a corresponding one of the second fastener receiving openings 148 to secure the first proximal end portion 102 to the first cable engagement portion 106.

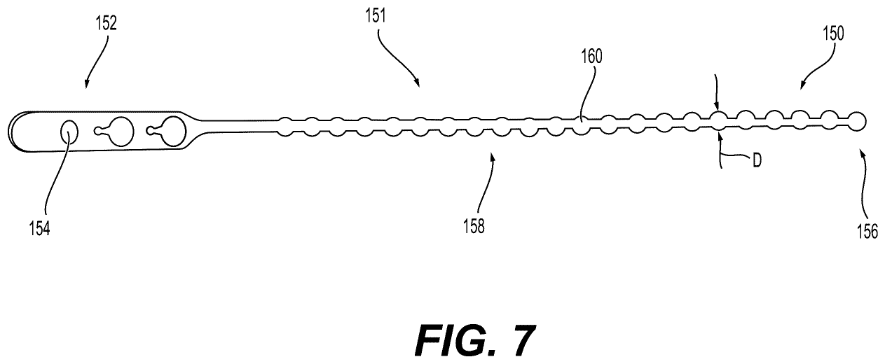

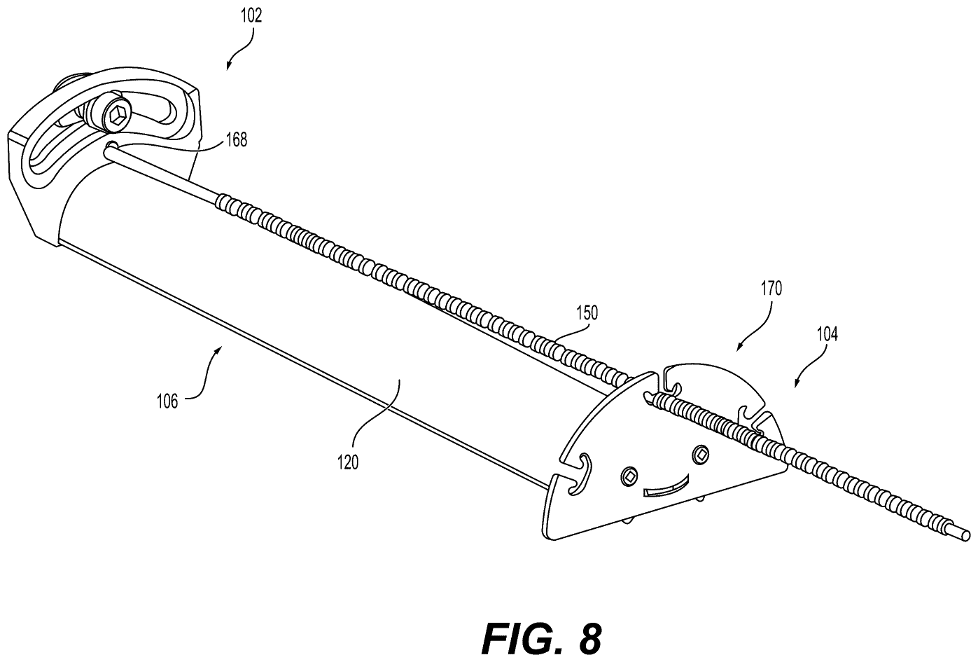

Referring to FIGS. 7-8, in some implementations, the cable management device 100 may be structurally configured to support a cable guiding member 150. The cable guiding member 150 may be structurally configured to keep the communication cables and or fibers being engaged and routed by the cable management device 100 adjacent to, or in close proximity with, the first cable engagement portion 106. For example, the cable guiding member 150 may be supported on the cable management device 100 to sandwich the communication cables, and/or fibers, between the first cable engagement surface 120 and the cable guiding member 150. In some implementations, the cable guiding member 150 may be structurally configured to extend along the first cable engagement surface 120 from the first proximal end portion 102 to the first distal end portion 104 and radially outward of the first cable engagement surface 120. In some implementations, the cable guiding member 150 may be a conventional ball cable tie 151 having a first end 152 defining an orifice 154, a second end 156 opposite the first end 152, and an elongated body 158 extending between the first end 152 and the second end 156. A series of spaced-apart beads 160 may extend along the elongated body 158.

The cable guiding member 150 may be supported on the cable management device 100 in a variety of ways. In some implementations, the first proximal end portion 102 may include a first guiding member mounting portion 162 (FIG. 4) structurally configured to mount the cable guiding member 150 to the first proximal end portion 102. In some implementations, the first guiding member mounting portion may be structurally configured to connect the first end 152 of the ball cable tie 151 to the first proximal end portion 102.

Referring to FIG. 4, in some implementations, the first guiding member mounting portion 162 may include a second projection 166 extending proximally from the first face 132 and a second opening 168. The second projection 166 may be structurally configured to be received in the orifice 154 of the ball cable tie 151 such that the first end 152 is attached to the first proximal end portion 102. The second opening 168 may extend through the first proximal end portion 102 from the first face 132 to the second face 134. The second opening 168 may be structurally configured to receive the elongated body 158 of the ball cable tie 151 therethrough such that the elongated body 158 extends distally from the first proximal end portion 102 toward the first distal end portion 104, as shown in FIG. 8.

In some implementations, the first distal end portion 104 may include a second guide mounting portion 170 structurally configured to mount the cable guiding member 150 to the first distal end portion 104. The second guide mounting portion 170 may be configured in a variety of ways. In some implementations, the second guide mounting portion 170 may include one or more guiding member attachment points 172 structurally configured to engage and hold that cable guiding member 150 to the first distal end portion 104. The one or more guiding member attachment points 172 may be configured in a variety of ways, such as, for example the number, the location, the orientation, and the shape of each guiding member attachment point 172.

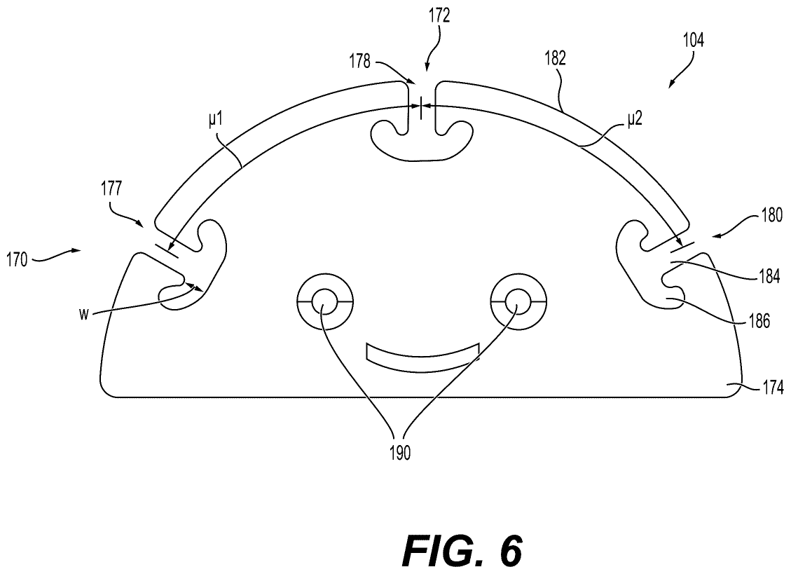

In some implementations, the first distal end portion 104 may include a first end plate portion 173 having a third face 174 (FIG. 6) and a fourth face 176 (FIG. 1) opposite the third face 174. In some implementations, first end plate portion 172 may include a semicircular profile. In some implementations, the one or more guiding member attachment points 172 may include a first guiding member attachment point 177, a second guiding member attachment point 178 spaced apart from the first guiding member attachment point 177, and a third guiding member attachment point 180 spaced apart from the first guiding member attachment point 177 and the second guiding member attachment point 178. In some implementations, the first, second, and third guiding member attachment points 177, 178, 180 may be structurally configured the same as one another but positioned at different locations and orientations on the first distal end portion 104.

For example, in some implementations, the first guiding member attachment point 177 may be positioned at a radially outer edge 182 of the first distal end portion 104. The second guiding member attachment point 178 may be positioned at the radially outer edge 182 at an angle μ1 from the first guiding member attachment point 176. In some implementations the angle μ1 is in the range of 40-80 degrees, or 50-70 degrees, or about 60 degrees. The third guiding member attachment point 180 may be positioned at the radially outer edge 182 at an angle μ2 from the second guiding member attachment point 178. In some implementations the angle μ2 is in the range of 40-80 degrees, or 50-70 degrees, or about 60 degrees. In some implementations, the angle μ2 is equal to the angle μ1. In other implementations, however, the angle μ2 may be different than the angle μ1.

In some implementations, each of the one or more guiding member attachment points 172 may be structurally configured to engage one of the spaced-apart beads 160 on the elongated body 158 of the ball cable tie 151. For example, in some implementations, each of the one or more guiding member attachment points 172 may have a radially extending channel 184 open at the radially outer edge 182 of the first distal end portion 104 and a pair of opposed lateral channels 186 such that the each of the one or more guiding member attachment points 172 is generally T-shaped. In some implementations, each lateral channels 186 may have a width W that is smaller than a diameter D of each of the spaced-apart beads 160 on the elongated body 158 of the ball cable tie 151.

The second end 156 of the ball cable tie 151 can be secured to the first distal end portion 104 by receiving the second end 156, or another portion of the elongated body 158, within radially extending channel 184 and then into one of the lateral channels 186 such that one of the spaced-apart beads 160 abuts or is adjacent the fourth face 176 of the first distal end portion 104.

In some implementations, the first distal end portion 104 may be formed integrally with the first cable engagement portion 106. In other implementations, the first distal end portion 104 may be separate from the first cable engagement portion 106 and may be structurally configured to attach to the first cable engagement portion 106. The first distal end portion 104 may be structurally configured to attach to the first cable engagement portion 106 in a variety of ways. In some implementations, the first distal end portion 104 may be structurally configured to attach to the first cable engagement portion 106 by one or more fasteners 188. For example, in the illustrated implementation, the first distal end portion 104 may include one or more third fastener receiving openings 190 structurally configured to receive the one or more fasteners 188 to attach the first distal end portion 104 to the first cable engagement portion 106.

Correspondingly, the first cable engagement portion 106 may include the one or more second fastener receiving openings 148 at the first distal end portion 104 for receiving the one or more fasteners 188. The spacing and orientation of the one or more second fastener receiving openings 148 may align with the spacing and orientation of the one or more third fastener receiving openings 190 such that the one of the one or more fasteners 188 may be received through one or more third fastener receiving openings 190 and a corresponding one of the second fastener receiving openings 148 to secure the first distal end portion 104 to the first cable engagement portion 106.

Referring to FIGS. 9-10, in some implementations, the first cable engagement portion 106 may be attached to the second cable engagement portion 206. The cable management device 100, however, may be used without the second cable engagement portion 206 being attached to the first cable engagement portion 106. In some implementations, the cable management device 100 may include a second proximal end portion 202, a second distal end portion 204 opposite the second proximal end portion 202, and the second cable engagement portion 206 extending between the second proximal end portion 202 and the second distal end portion 204.

In some implementations, the second proximal end portion 202, the second distal end portion 204, and the second cable engagement portion 206 may be structurally configured the same as the first proximal end portion 102, the first distal end portion 104, and the first cable engagement portion 106. For example, in some embodiments, the second distal end portion 204 may include a second end plate portion 207. Thus, the description of the first proximal end portion 102, the first distal end portion 104, and the first cable engagement portion 106 applies equally to the second proximal end portion 202, the second distal end portion 204, and the second cable engagement portion 206.

In some implementations, the second cable engagement portion 206 may be structurally configured to attach to the first cable engagement portion 106. The second cable engagement portion 206 may define a second cable engagement surface 220 structurally configured to engage the one or more communication cables. In some implementations, when the first cable engagement portion 106 and the second cable engagement portion 206 are attached, the first cable engagement surface 120 and the second cable engagement surface 220 may form a circular cross-section profile. For example, in some implementations, the second cable engagement portion 206 may be structurally configured the same as the first cable engagement portion 106 and may be inverted with respect to the first cable engagement portion 106 when attached to the first cable engagement portion 106.

In some implementations, the second cable engagement portion 206 may include connecting portions that are complementary to the connecting portion on the first cable engagement portion 106. For example, the second cable engagement portion 206 may include a third connecting portion 222 and a fourth connecting portion 224 structurally configured the same as the first connecting portion 122 and second connecting portion 124, respectively, of the first cable engagement portion 106. Thus, in some implementations, the third connecting portion 222 may include a longitudinally-extending groove 226 and the fourth connecting portion 224 may include a longitudinally-extending ridge 228.

When connected, the second cable engagement portion 206 may be inverted and attached to the first cable engagement portion 106 such that the longitudinally-extending ridge 228 of the fourth connecting portion 224 is received in the longitudinally-extending groove 126 of the first connecting portion 122 and the longitudinally-extending ridge 128 of the second connecting portion 124 is received in the longitudinally-extending groove 226 of the third connecting portion 222. Connecting the first cable engagement portion 106 to the second cable engagement portion 206 may result in a significantly sturdier cable engagement portion than just the first cable engagement portion 106 alone.

In some implementations, the second proximal end portion 202 and the second distal end portion 204 may be structurally configured to attach to the second cable engagement portion 206 by fasteners in the same way as described in relation to the first proximal end portion 102 and the first distal end portion 104 attaching to the first cable engagement portion 106. For example, in some implementations, the second cable engagement portion 206 may include fourth fastener receiving openings 248 configured like the second fastener receiving openings 148 of the first cable engagement portion 106.

In some implementations, the fourth fastener receiving openings 248 and the second fastener receiving openings 148 may be structurally configured (e.g., the location and the spacing of the second and fourth fastener receiving openings 148, 248) to allow each of the first and second proximal end portions 102, 202 and the first and second distal end portions 104, 204 to attach to both of the first cable engagement portion 106 and the second cable engagement portion 206. Attaching each of the first and second proximal end portions 102, 202 and/or the first and second distal end portions 104, 204 to both the first cable engagement portion 106 and the second cable engagement portion 206 may add structural strength to the cable management device 100 versus having the first proximal end portion 102 and the first distal end portion 104 attach to the first cable engagement portion 106 and not the second cable engagement portion 206.

For example, as shown in FIG. 9, the first and second proximal end portions 102, 202 and/or the first and second distal end portions 104, 204 may be rotated 90 degrees relative to the first and second cable engagement portions 106, 206, respectively, such that one of the first fastener receiving openings 146 aligns with one of the second fastener receiving openings 148 and the other of the first fastener receiving openings 146 aligns with one of the fourth fastener receiving openings 248. The second proximal end portions 202, the first distal end portions 104, and the second distal end portion 204, can be arranged (e.g., to span across) and attached to both of the first cable engagement portion 106 and the second cable engagement portion 206 in a like manner.

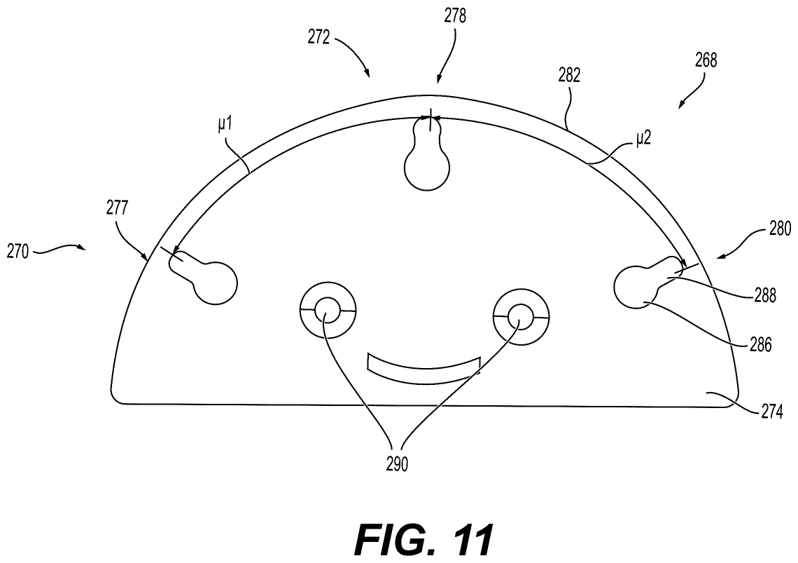

FIG. 11 illustrates an example first distal end portion 268 and second guide mounting portion 270 structurally configured to mount the cable guiding member 150 (FIG. 7) to the first distal end portion 268. The second guide mounting portion 270 may be configured in a variety of ways. In some implementations, the second guide mounting portion 270 may include one or more guiding member attachment points 272 structurally configured to engage and hold that cable guiding member 150 to the first distal end portion 268. The one or more guiding member attachment points 272 may be configured in a variety of ways, such as, for example the number, the location, the orientation, and the shape of each guiding member attachment point 272.

In some implementations, the first distal end portion 268 may include a first end plate portion 273 having a third face 274 (FIG. 11) and a fourth face (not shown) (e.g., similar to fourth face 176 of the first distal end portion 104) opposite the third face 274 (e.g. parallel to the third face 274). In some implementations, the first end plate portion 273 may have a semicircular profile. In some implementations, the one or more guiding member attachment points 272 may include a first guiding member attachment point 277, a second guiding member attachment point 278 spaced apart from the first guiding member attachment point 277, and a third guiding member attachment point 280 spaced apart from the first guiding member attachment point 277 and the second guiding member attachment point 278. In some implementations, the first, second, and third guiding member attachment points 277, 278, 280 may be structurally configured the same as one another but positioned at different locations and orientations on the first distal end portion 268.

For example, in some implementations, the first guiding member attachment point 277 may be positioned adjacent or near a radially outer edge 282 of the first distal end portion 268. The second guiding member attachment point 278 may be positioned adjacent or near the radially outer edge 282 at an angle μ1 from the first guiding member attachment point 277. In some implementations the angle μ1 may be in the range of 40-80 degrees, or 50-70 degrees, or about 60 degrees. The third guiding member attachment point 280 may be positioned adjacent or near the radially outer edge 282 at an angle μ2 from the second guiding member attachment point 278. In some implementations the angle μ2 may be in the range of 40-80 degrees, or 50-70 degrees, or about 60 degrees. In some implementations, the angle μ2 may be equal to the angle μ1. In other implementations, however, the angle μ2 may be different than the angle μ1.

In some implementations, each of the one or more guiding member attachment points 272 may be structurally configured to engage and secure the cable guiding member 150 at the first distal end portion 268 (e.g., engage one of the spaced-apart beads 160 on the elongated body 158 of the ball cable tie 151). For example, in some implementations, each of the one or more guiding member attachment points 272 may include an aperture 284 having a wider portion 286 and a narrower portion 288. In some embodiments, the narrower portion 288 may be closer to the radial outer edge 282 than the wider portion 286.

In some embodiments, the narrower portion 288 may be structurally configured to secure the cable guiding member 150 in the narrower portion 288 (e.g., prevent the cable guiding member 150 from being drawn through the narrower portion 288). For example, in some embodiments, the wider portion 286 may be structurally configured to allow the cable guiding member 150 to be received through the wider portion 286 and then moved radially outward such that the cable guiding member 150 is received in the narrower portion 288 to secure the cable guiding member 150 to the first distal end portion 268 (e.g., the narrower portion 288 is narrower than the beads 160 on the ball cable tie 151).

In some implementations, the first distal end portion 268 may be formed integrally with the first cable engagement portion 106 (e.g., FIG. 1). In other implementations, the first distal end portion 268 may be separate from the first cable engagement portion 106 and may be structurally configured to attach to the first cable engagement portion 106. The first distal end portion 268 may be structurally configured to attach to the first cable engagement portion 106 in a variety of ways. In some implementations, the first distal end portion 268 may be structurally configured to attach to the first cable engagement portion 106 by one or more fasteners (e.g., fasteners 188). For example, in the illustrated implementation, the first distal end portion 268 may include one or more third fastener receiving openings 290 structurally configured to receive the one or more fasteners to attach the first distal end portion 268 to the first cable engagement portion 106.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A device for managing communication cables within an enclosure structurally configured to permit changing of an angular orientation of a cable engagement surface and to provide the cable engagement surface with enhanced strength for supporting and routing cables inside the enclosure, comprising:
a proximal end portion;
a distal end portion opposite the proximal end portion;
a cable engagement portion extending along a longitudinal axis between the proximal end portion and the distal end portion;
wherein the cable engagement portion defines a cable engagement surface structurally configured to engage a communication cable;
wherein the proximal end portion includes a mounting portion structurally configured to mount to an enclosure;
wherein the mounting portion includes a proximally extending projection structurally configured to be received within a recess of the enclosure and a first curved slot structurally configured to receive a mounting fastener for attaching the device to the enclosure;
wherein the mounting portion is structurally configured to allow the cable engagement surface to pivot about the longitudinal axis so as to permit an angular orientation of the cable engagement surface to be changed without detaching the mounting portion from the enclosure;
wherein the proximal end portion includes a first guiding member mounting portion structurally configured to mount a cable guiding member to the proximal end portion, wherein the cable guiding member is structurally configured to extend along the cable engagement surface from the proximal end portion to the distal end portion and spaced radially outward of the cable engagement surface;
wherein the distal end portion includes a second guiding member mounting portion structurally configured to mount the cable guiding member to the distal end portion;
wherein the second guiding member mounting portion includes a first guiding member attachment point, a second guiding member attachment point spaced from the first guiding member attachment point, and a third guiding member attachment point spaced apart from the first guiding member attachment point and the second guiding member attachment point, wherein the first guiding member attachment point is positioned near a radially outer edge of the distal end portion, the second guiding member attachment point is positioned near the radially outer edge offset 40-80 degrees from the first guiding member attachment point, and the third guiding member attachment point is positioned near the radially outer edge offset 40-80 degrees from the second guiding member attachment point;
wherein the cable engagement portion includes a first cable engagement portion structurally configured to interlock with a second cable engagement portion so as to provide a cylindrical cable engagement surface having enhanced strength for supporting and routing cables; and
wherein the device is structurally configured to permit changing of an angular orientation of the cable engagement surface and to provide the cable engagement surface with enhanced strength for supporting and routing cables inside the enclosure.

2. The device according to claim 1, wherein first cable engagement surface is convex.

3. The device according to claim 1, wherein the mounting portion is structurally configured to attach to the cable engagement portion with one or more fasteners.

4. The device according to claim 1, wherein the distal end portion includes a first distal end portion structurally configured to span across and connect to both the first cable engagement portion and the second cable engagement portion and a second distal end portion structurally configured to span across and connect to both the first cable engagement portion and the second cable engagement portion adjacent the first distal end portion.

5. The device according to claim 1, wherein the first guiding member mounting portion is structurally configured to mount a ball cable tie and includes a proximally extending second projection structurally configured to be received in a ball end of the ball cable tie and an opening through which the ball cable tie extend distally, and wherein each of the first, second, and third cable guiding member attachment points are structurally configured to engage a bead of the ball cable tie to secure the ball cable tie at the distal end portion.

6. A device for managing communication cables within an enclosure structurally configured to permit changing of an angular orientation of the cable engagement surface and to provide the cable engagement surface with enhanced strength for supporting and routing cables inside the enclosure, comprising:
a proximal end portion;
a distal end portion opposite the proximal end portion;
a cable engagement portion extending along a longitudinal axis between the proximal end portion and the distal end portion;
wherein the cable engagement portion defines a cable engagement surface structurally configured to engage a communication cable;
wherein the proximal end portion includes a mounting portion structurally configured to mount to an enclosure;
wherein the mounting portion is structurally configured to allow the cable engagement surface to pivot about the longitudinal axis so as to permit an angular orientation of the cable engagement surface to be changed without detaching the mounting portion from the enclosure;
wherein the proximal end portion includes a first guiding member mounting portion structurally configured to mount a cable guiding member to the proximal end portion, wherein the cable guiding member is structurally configured to extend along the cable engagement surface from the proximal end portion to the distal end portion and spaced radially outward of the cable engagement surface;
wherein the distal end portion includes a second guiding member mounting portion structurally configured to mount the cable guiding member to the distal end portion;
wherein the second guiding member mounting portion includes a plurality of circumferentially spaced attachment points;
wherein the cable engagement portion includes a first cable engagement portion structurally configured to interlock with a second cable engagement portion so as to provide a cylindrical cable engagement surface having enhanced strength for supporting and routing cables; and
wherein the device is structurally configured to permit changing of an angular orientation of the cable engagement surface and to provide the cable engagement surface with enhanced strength for supporting and routing cables inside the enclosure.

7. The device according to claim 6, wherein the second guiding member mounting portion includes a first guiding member attachment point, a second guiding member attachment point spaced from the first guiding member attachment point, and a third guiding member attachment point spaced apart from the first guiding member attachment point and the second guiding member attachment point.

8. The device according to claim 7, wherein the first guiding member attachment point is positioned near a radially outer edge of the distal end portion, the second guiding member attachment point is positioned near the radially outer edge offset 40-80 degrees from the first guiding member attachment point, and the third guiding member attachment point is positioned near the radially outer edge offset 40-80 degrees from the second guiding member attachment point.

9. The device according to claim 6, wherein the distal end portion includes a first distal end portion structurally configured to span across and connect to both the first cable engagement portion and the second cable engagement portion and a second distal end portion structurally configured to span across and connect to both the first cable engagement portion and the second cable engagement portion adjacent the first distal end portion.

10. The device according to claim 6, wherein the cable engagement surface is convex.

11. A device for managing communication cables within an enclosure structurally configured to permit changing of an angular orientation of the cable engagement surface and to provide the cable engagement surface with enhanced strength for supporting and routing cables inside the enclosure, comprising:
a proximal end portion;
a distal end portion opposite the proximal end portion;
a cable engagement portion extending along a longitudinal axis between the proximal end portion and the distal end portion;
wherein the cable engagement portion defines a cable engagement surface structurally configured to engage a communication cable;
wherein the proximal end portion includes a mounting portion structurally configured to mount to an enclosure;
wherein the mounting portion is structurally configured to allow the cable engagement surface to pivot about the longitudinal axis so as to permit an angular orientation of the cable engagement surface to be changed without detaching the mounting portion from the enclosure; and
wherein the device is structurally configured to permit changing of an angular orientation of the cable engagement surface and to provide the cable engagement surface with enhanced strength for supporting and routing cables inside the enclosure.

12. The device according to claim 11, wherein the cable engagement portion includes a first cable engagement portion structurally configured to interlock with a second cable engagement portion so as to provide a cylindrical cable engagement surface having enhanced strength for supporting and routing cables.

13. The device according to claim 12, wherein the distal end portion includes a first distal end portion structurally configured to span across and connect to both the first cable engagement portion and the second cable engagement portion and a second distal end portion structurally configured to span across and connect to both the first cable engagement portion and the second cable engagement portion adjacent the first distal end portion.

14. The device according to claim 11, wherein the second guiding member mounting portion includes a plurality of circumferentially spaced attachment points.

15. The device according to claim 14, wherein the second guiding member mounting portion includes a first guiding member attachment point, a second guiding member attachment point spaced from the first guiding member attachment point, and a third guiding member attachment point spaced apart from the first guiding member attachment point and the second guiding member attachment point.

16. The device according to claim 15, wherein the first guiding member attachment point is positioned near a radially outer edge of the distal end portion, the second guiding member attachment point is positioned near the radially outer edge offset 40-80 degrees from the first guiding member attachment point, and the third guiding member attachment point is positioned near the radially outer edge offset 40-80 degrees from the second guiding member attachment point.

17. The device according to claim 14, wherein the first guiding member mounting portion is structurally configured to mount a ball cable tie and includes a proximally extending second projection structurally configured to be received in a ball end of the ball cable tie and an opening through which the ball cable tie extend distally, and wherein the plurality of circumferentially spaced attachment points are structurally configured to engage a bead of the ball cable tie to secure the ball cable tie at the distal end portion.

18. The device according to claim 11, wherein the cable engagement surface is convex.

19. The device according to claim 11, wherein the mounting portion includes a proximally extending projection structurally configured to be received within a recess of the enclosure and a first curved slot structurally configured to receive a mounting fastener of attaching the device to the enclosure.

20. The device according to claim 11, wherein the mounting portion is structurally configured to attach to the cable engagement portion with one or more fasteners.

21. The device according to claim 11, wherein the proximal end portion includes a first guiding member mounting portion structurally configured to mount a cable guiding member to the proximal end portion, wherein the cable guiding member is structurally configured to extend along the cable engagement surface from the proximal end portion to the distal end portion and spaced radially outward of the cable engagement surface.

22. The device according to claim 21, wherein the distal end portion includes a second guiding member mounting portion structurally configured to mount the cable guiding member to the distal end portion.
